(19) United States
(12) Patent Application Publication
(10) Pub. No.: US 2011/0084526 A1
(43) Pub. Date: Apr. 14, 2011

(54) CHAIR AND METHOD FOR MANUFACTURE THEREOF

(75) Inventor: Laurens Sneujink, Sint Philpsland (NL)

(73) Assignee: Casala Meubelen Nederland B.V.

(21) Appl. No.: 12/446,435

(22) PCT Filed: Oct. 19, 2007
(86) PCT No.: PCT/NL07/00268

§ 371 Date: Dec. 8, 2010

(30) Foreign Application Priority Data
Oct. 20, 2006 (NL) 1032708

(51) Int. Cl. A47C 3/04; A47C 1/124; B23P 11/00

(52) U.S. Cl. 297/239; 297/248; 29/428

(57) ABSTRACT

A chair includes four legs for placing on a ground surface and a seat mounted on the legs at a predetermined height relative to the ground surface, wherein space is left clear between the seat and the legs on at least one side of the seat for the purpose of receiving the legs of an adjacent chair, this space being bounded by frame parts for close fitting round legs of an adjacent chair, and a backrest arranged above the level of the seat.

### FIELD OF THE INVENTION

The present application relates to a chair and a method for the manufacture thereof.

### BACKGROUND INFORMATION

In addition to appearance and seating comfort, there are in respect of chairs also other considerations as to whether or not to purchase a specific chair. If a large number of chairs have to be disposed in a public hall, such as in school buildings, assembly halls and the like, the stackability and the ease with which they can be coupled to each other are of great importance.

British Published Patent Application No. 930,158 describes stackable chairs without armrests which can be coupled at the sides. The construction of the chair is however unnecessarily complicated—the frame is changed on both sides rather drastically compared to a usual chair.

German Published Patent Application No. 199 44 503 describes a stackable chair with armrests wherein the legs engage in each other.

French Published Patent Application No. 1,333,136 describes a chair which is stackable and coupleable to another chair, including four legs for placing on the ground surface, a seat mounted on the legs at a predetermined height relative to the ground surface, and a backrest arranged above the level of the seat, and armrests which are formed or supported by the legs which extend beyond the level of the seat, wherein space is left clear between the seat and the legs at least one side of the seat for the purpose of receiving the legs of an adjacent chair.

As the legs of this chair extend to the armrests, this chair can easily be raised and stacked or coupled.

### SUMMARY

Example embodiments of the present invention improve upon these stackable and coupleable chairs, and enlarge the stiffness of the coupling between chairs, which is very important in case of an emergency.

Example embodiments of the present invention provide a chair which is stackable and coupleable, including four legs for placing on the ground surface, a seat mounted on the legs at a predetermined height relative to the ground surface, and a backrest arranged above the level of the seat, and armrests which are formed or supported by the legs which extend beyond the level of the seat, wherein space is left clear between the seat and the legs at least one side of the seat for the purpose of receiving the legs of an adjacent chair, wherein the frame parts are attached to the legs through two curved flanges, wherein the curved flanges have opposite curvature, such as to provide for close fitting of the flanges around the legs of an adjacent chair.

In accordance with example embodiments of the present invention, a number of chairs can be placed next to each other in relatively simple manner and be coupled to each other by the placing, while they are also readily stackable. With example embodiments of the present invention, in an emergency situation a row of for instance twelve, thirteen or more chairs remain coupled when they tip over backwards, so that in such an emergency situation the people seated on the chairs are not hindered by the chairs, or hardly so, as they get out as quickly as possible from between the rows.

The chair according to example embodiments of the present invention is preferably provided with an armrest on both sides which, in addition to increasing seating comfort, also increases the rigidity of the rows and makes stacking and coupling in rows easier, since the chair can be lifted by the armrests.

In example embodiments, the legs extend beyond the level of the seat so that the armrests and the legs are easy to manufacture.

In example embodiments, the lying part of the armrest is provided in plastic in order to increase comfort, and this also facilitates lifting.

The frame parts may form part of a lower frame on which the seat is arranged; if a lower frame having the free space for the legs of the adjacent chair is manufactured sufficiently precisely, i.e. with a tolerance of less than several millimeters, a chair which can be manufactured economically is thus obtained.

Example embodiments of the present invention provide a method wherein the tubes for the lower frame are formed with the required precision in a mold. Due to this manufacturing method the required accuracy can be sufficiently guaranteed.

Further advantages and features relating to example embodiments of the present invention will be elucidated on the basis of the following description, in which reference is made to the Figures.

### BRIEF DESCRIPTION OF THE DRAWINGS

FIG. 1 shows a perspective view of a chair according to an example embodiment of the present invention;

FIG. 2 shows a perspective view of two stacked chairs of FIG. 1;

FIG. 3 is a perspective view of two chairs of FIG. 1 disposed adjacently of and coupled to each other;

FIGS. 4 to 6 show front views of respective positions during coupling of the chairs of FIG. 1;

FIG. 7 shows a cross-sectional view along line VII-VII in FIG. 6;

FIG. 8 is a perspective view of a chair according to an example embodiment of the present invention;

FIG. 9 is a perspective view of two stacked chairs of FIG. 8;

FIG. 10 is a perspective view of two chairs of FIG. 8 disposed adjacently of and coupled to each other;

FIG. 11 shows a cross-section of the coupling of the chairs of FIG. 10;

FIG. 12 shows a perspective view of a chair according to an example embodiment of the present invention;

FIG. 13 is a perspective view of two stacked chairs;

FIG. 14 shows a view of two chairs of FIG. 12 disposed adjacently of and coupled to each other; and

FIG. 15 shows a cross-sectional view of the coupling of the chairs of FIG. 14.

### DETAILED DESCRIPTION

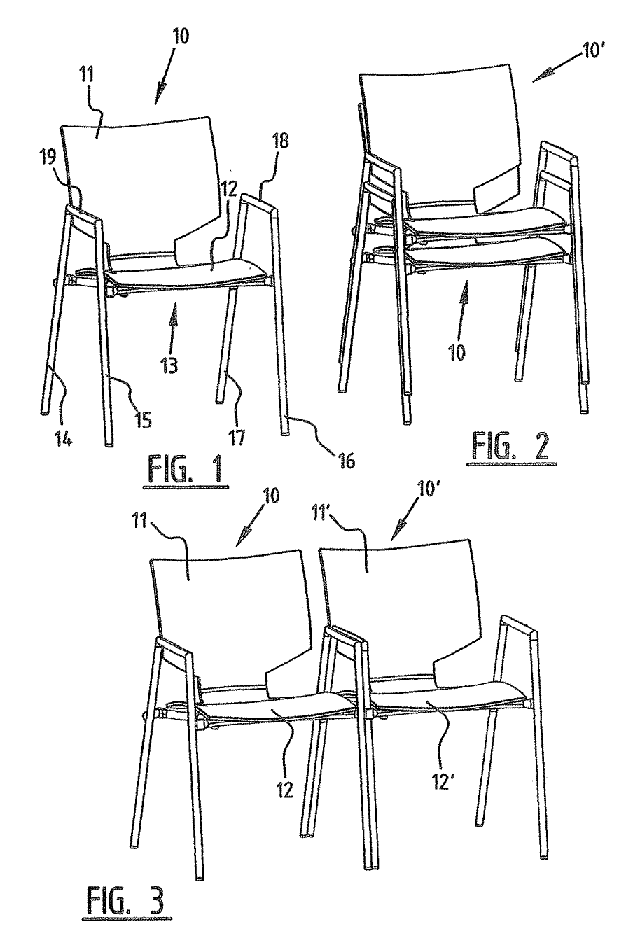

A chair 10, 10′ (FIGS. 1 to 6) includes a backrest 11, a seat 12 arranged on a lower frame 13, legs 14, 15, 16, 17 and armrests 18, 19. Legs 14-17 are preferably of metal and extend above seat 12 in order to arrange therein the armrests 18, 19, which are preferably manufactured from plastic material. The chairs can be lifted up easily by the armrests and stacked on each other (FIG. 2). They can also be placed in coupled manner adjacently of each other (FIG. 3).

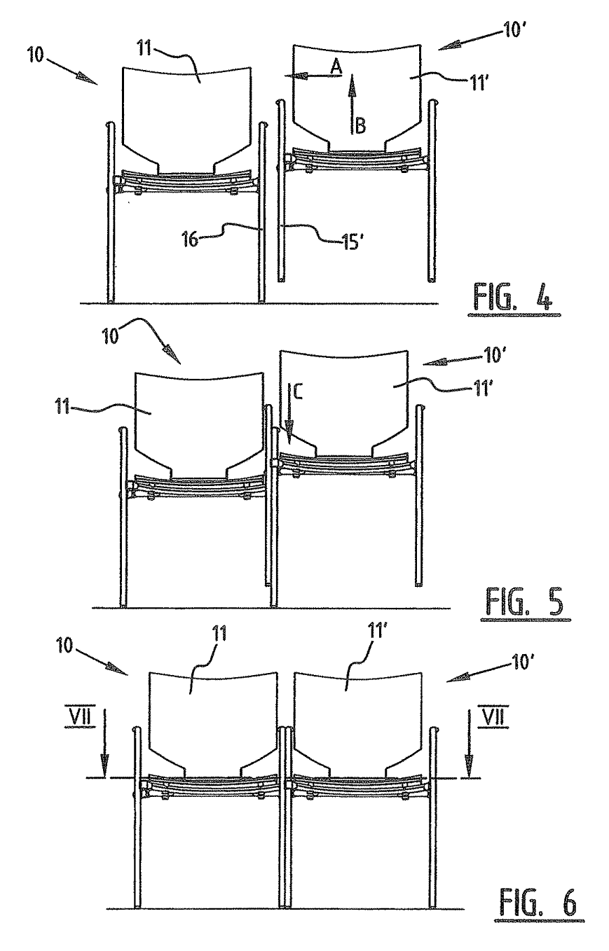

The chairs are coupled stably and rigidly in simple and practical manner (FIG. 6) when chair 10′ is lifted (FIG. 4) in the direction of arrow A, wherein leg 15′ is carried beyond leg 16 of chair 10 and subsequently moved laterally in the direction of arrow B and downward in the direction of arrow C (FIG. 5).

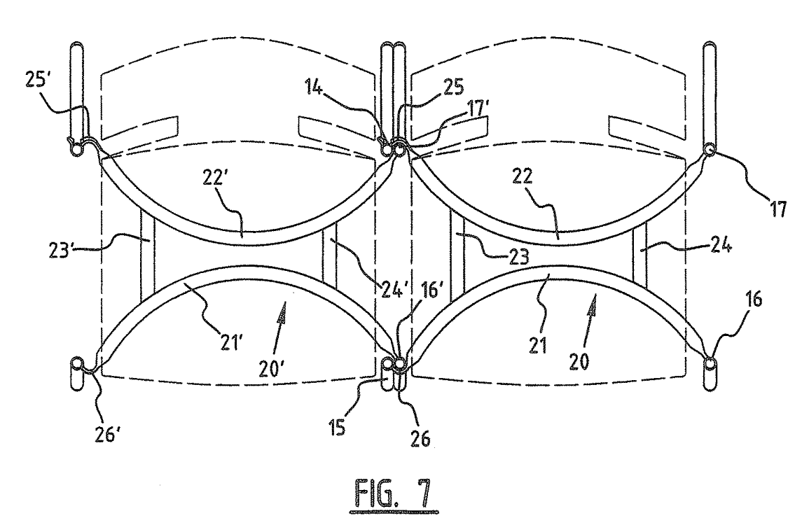

As shown particularly in FIG. 7, a lower frame 20 includes two curved tubes 21, 22 which are mutually connected via two connecting tubes 23, 24. The round tubes 21, 22 are each provided at an outer end with a curved flange 25, 26 respectively, wherein the concave side of these curved flanges face toward each other. Due to these curved flanges, space is provided in simple manner for the legs of an adjacent chair.

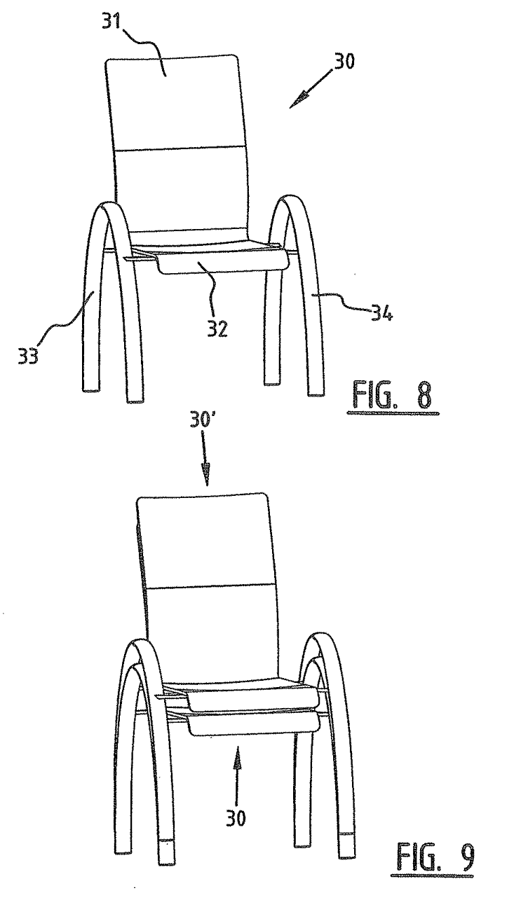

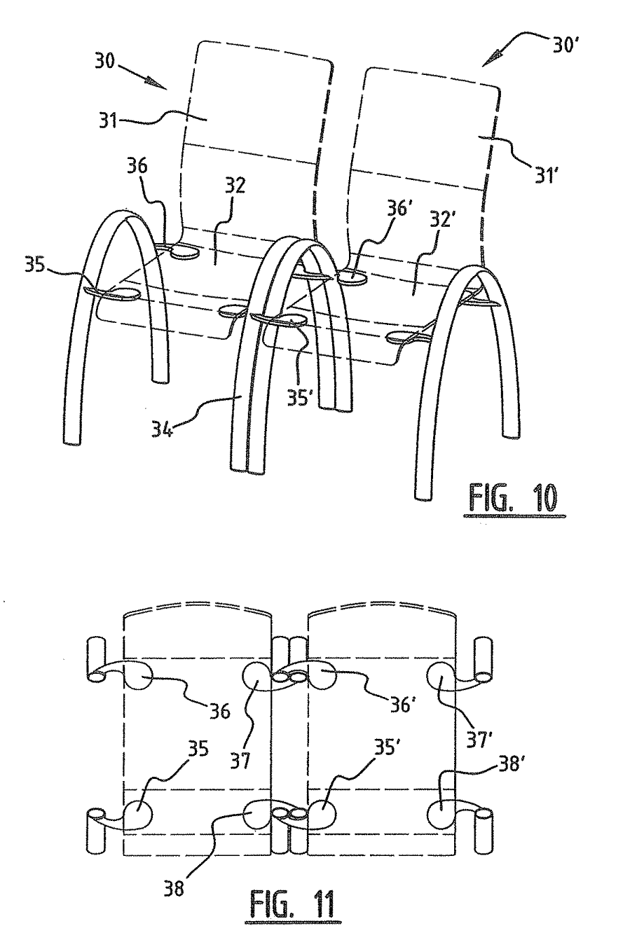

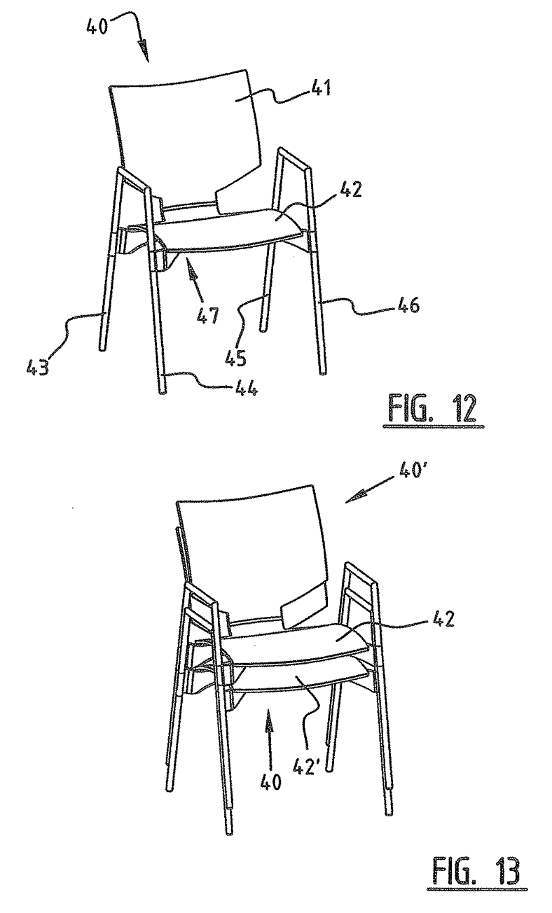

An example embodiment of a chair 30 includes a backrest 31, a seat 32 and curved legs 33, 34 (FIG. 8) which also form the armrest. The chair is easily stackable, as shown in FIG. 9. In a manner corresponding with chairs 10, 10′, chairs 30 and 30′ can be arranged coupled adjacently of each other (FIG. 10). The chairs are provided in each case with curved flanges 35, 36, 37, 38 which provide space for the legs of the adjacent frame—see also FIG. 11.

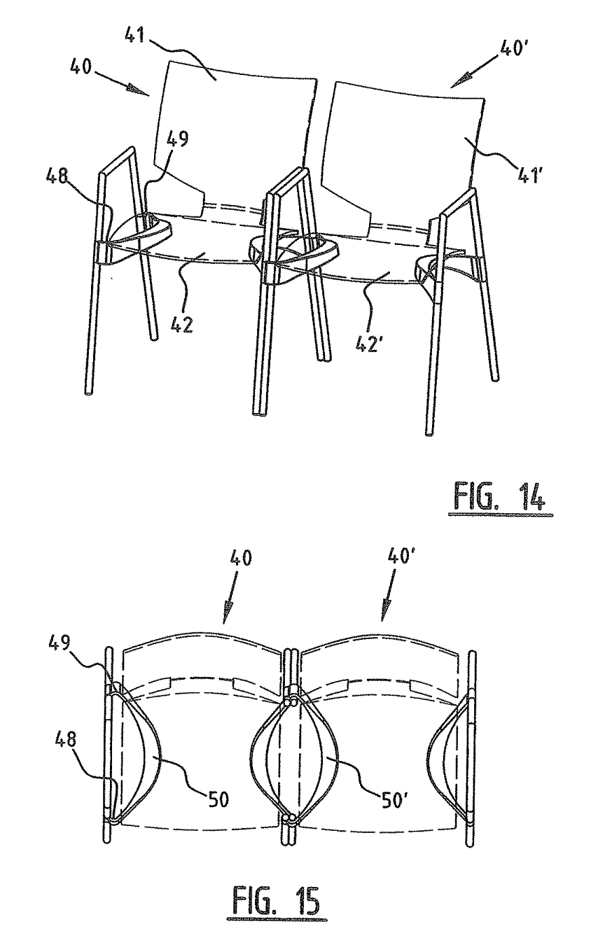

In an example embodiment 40, which also includes a backrest 41 and a seat 42, space is also provided by the placing of legs 43, 44, 45, 46 relative to a lower frame 47 for precise accommodation therein of the legs of the adjacent chair (see FIG. 14), while they are also easily stackable (FIG. 13). The curved flanges 48, 49 arranged on curved cast parts 50, 50′ are best seen in FIG. 15.

The legs can be inserted downward through the lower frame of the seat from above at a precise oblique angle and to some extent in rearward direction; the accuracy of the shaped frame is important here in obtaining a stable position for chairs disposed in a row.

In order to achieve this accuracy the lower frame is preferably manufactured from metal using a mold, whereby the flanges are as it were made integrally with the frame so that the position thereof is then sufficiently accurate for easy fixing, for instance welding, of the legs thereto.

The present invention is not limited to the above described example embodiments thereof; the rights sought are defined by the following claims, within the scope of which many modifications can be envisaged.

1-5. (canceled)

6. A chair, comprising:
four legs adapted for placement on a ground surface;
a seat mounted on the legs at a predetermined height relative to the ground surface, space being left clear between the seat and the legs on at least one side of the seat and adapted to receive the legs of an adjacent chair, the being bounded by frame parts for close fitting round legs of an adjacent chair; and
a backrest arranged above a level of the seat.

7. The chair according to claim 6, further comprising a lower frame, the seat arranged on the lower frame, frame parts forming a part of the lower frame.

8. The chair according to claim 7, wherein the lower frame includes curved tubes, and the curved tubes include mutually connecting connecting tubes.

9. A stackable and coupleable chair, comprising:
four legs adapted for placement on a ground surface;
a seat mounted on the legs at a predetermined height relative to the ground surface;
a backrest arranged above a level of the seat; and
armrests at least one of (a) formed and (b) supported by the legs which extend beyond a level of the seat;
wherein a space is left clear between the seat and the legs on at least one side of the seat and is adapted to receive the legs of an adjacent chair;
wherein frame parts are attached to the legs by two curved flanges; and
wherein the curved flanges have opposite curvatures to provide for close fitting of the flanges around the legs of an adjacent chair.

10. The chair according to claim 9, wherein a lying part of the armrests is formed of plastic and is fixed to the extended legs.

11. The chair according to claim 9, further comprising a lower frame, the seat arranged on the lower frame, frame parts forming a part of the lower frame.

12. The chair according to claim 11, wherein the lower frame includes curved tubes, and the curved tubes include mutually connecting connecting tubes.

13. The chair according to claim 9, wherein the chair is coupleable with at least one identical chair.

14. A stackable chair, coupleable with at least one identical chair, comprising:
four legs adapted to place the chair in an upright position on a ground surface;
a lower frame connected to the legs;
a seat mounted on the lower frame at a predetermined level relative to the ground surface;
a backrest arranged above the level of the seat; and
armrests at least one of (a) formed and (b) supported by the legs, the armrests extending above the level of the seat;
wherein a space is left clear between the seat and the legs on at least one side of the seat and is adapted to receive legs arranged on an opposite side of the seat of an adjacent chair to couple the chair and the adjacent chair;
wherein the lower frame is attached to the legs on the side of the seat via two curved flanges extending across the clear space;
wherein the curved flanges have opposite curvatures in close correspondence with the legs of the adjacent chair; and
wherein in a coupled state of the chair and the adjacent chair, the flanges on the lower frame of the chair close fittingly accommodate and engage the legs of the adjacent chair.

15. The chair according to claim 14, wherein a lying part of the armrests is formed of plastic and is fixed to the extended legs.

16. The chair according to claim 14, further comprising a lower frame, the seat arranged on the lower frame, frame parts forming a part of the lower frame.

17. The chair according to claim 16, wherein the lower frame includes curved tubes, and the curved tubes include mutually connecting connecting tubes.

18. A method for manufacturing a lower frame for a stackable and coupleable chair including four legs adapted for placement on a ground surface, a seat mounted on the legs at a predetermined height relative to the ground surface, a backrest arranged above a level of the seat, and armrests at least one of (a) formed and (b) supported by the legs which extend beyond a level of the seat, a space being left clear between the seat and the legs on at least one side of the seat and being adapted to receive the legs of an adjacent chair, frame parts being attached to the legs by two curved flanges, and the curved flanges having opposite curvatures to provide for close fitting of the flanges around the legs of an adjacent chair, the seat being arranged on the lower frame, comprising:
fixing curved tubes of the lower frame and mutually connecting connecting tubes of the lower frame to each other in a mold.

19. A method for manufacturing a lower frame for a stackable chair, coupleable with at least one identical chair, the chair including four legs adapted to place the chair in an upright position on a ground surface, a lower frame connected to the legs, a seat mounted on the lower frame at a predetermined level relative to the ground surface, a backrest arranged above the level of the seat, and armrests at least one of (a) formed and (b) supported by the legs, the armrests extending above the level of the seat, a space being left clear between the seat and the legs on at least one side of the seat and being adapted to receive legs arranged on an opposite side of the seat of an adjacent chair to couple the chair and the adjacent chair, the lower frame being attached to the legs on the side of the seat via two curved flanges extending across the clear space, the curved flanges having opposite curvatures in close correspondence with the legs of the adjacent chair, in a coupled state of the chair and the adjacent chair, the flanges on the lower frame of the chair close fittingly accommodating and engaging the legs of the adjacent chair, the seat being arranged on the lower frame, comprising:
fixing curved tubes of the lower frame and mutually connecting connecting tubes of the lower frame to each other in a mold.
